(19) United States
(12) Patent Application Publication
(10) Pub. No.: US 2014/0226011 A1
(43) Pub. Date: Aug. 14, 2014

(54) TRAFFIC LANE RECOGNIZING APPARATUS AND METHOD THEREOF

(71) Applicant: LG ELECTRONICS INC., Seoul (KR)

(72) Inventors: Youngkyung Park, Seoul (KR); Jonghun Kim, Gyeonggi-Do (KR); Joongjae Lee, Seoul (KR); Hyunsoo Kim, Incheon (KR); Junoh Park, Seoul (KR); Jeihun Lee, Seoul (KR); Andreas Park, Seoul (KR); Chandra Shekhar Dhir, Seoul (KR)

(21) Appl. No.: 14/236,099

(22) PCT Filed: Jan. 9, 2012
(86) PCT No.: PCT/KR2012/000189

§ 371 Date: Apr. 28, 2014

(30) Foreign Application Priority Data
Aug. 4, 2011 (KR) 10-2011-0077922

(51) Int. Cl. G06K 9/00

(52) U.S. Cl. CPC G06K 9/00798
USPC 348/148

(57) ABSTRACT

Disclosed is a traffic lane recognizing apparatus and a method thereof. The traffic lane recognizing apparatus includes: a camera module; a display unit displaying an image captured by the camera module; and a controller detecting candidate traffic lanes from an image captured by the camera module, detecting double lines from the detected candidate traffic lanes, selecting a first traffic lane adjacent to a vehicle from among the detected double lines, selecting a second traffic lane adjacent to the vehicle from among the candidate traffic lanes, excluding the double lines, and displaying the first traffic lane and the second traffic lane on the image.

### TECHNICAL FIELD

The present invention relates to a traffic lane recognizing apparatus and a method thereof.

### BACKGROUND ART

In general, a traffic lane recognizing apparatus is an apparatus for recognizing a traffic lane included in a certain image input from a camera, or the like, or a certain image received from an external terminal. A related art traffic lane recognizing apparatus is disclosed in Korean Patent Publication Laid Open No. 1995-0017509.

### DISCLOSURE OF INVENTION

### Solution to Problem

According to an aspect of the present invention, there is provided a traffic lane recognizing apparatus including: a camera module; a display unit displaying an image captured by the camera module; and a controller detecting candidate traffic lanes from an image captured by the camera module, detecting double lines from the detected candidate traffic lanes, selecting a first traffic lane adjacent to a vehicle from among the detected double lines, selecting a second traffic lane adjacent to the vehicle from among the candidate traffic lanes, excluding the double lines, and displaying the first traffic lane and the second traffic lane on the image.

In an example related to the present disclosure, the controller may determine traffic lanes whose interval therebetween is a pre-set interval or smaller, among the detected candidate traffic lanes, as double lines.

In an example related to the present disclosure, the double lines may be double lines of solid lines, double lines of dotted lines, or double lines of a solid line and a dotted line.

In an example related to the present disclosure, the controller may detect the traffic lanes by extracting traffic lane feature points from the image, converting the extracted traffic lane feature points into world coordinates, and tracking the traffic lane feature points which have been converted into the world coordinates.

In an example related to the present disclosure, the controller may detect the traffic lanes by extracting traffic lane feature points from the image based on pre-set guide lines, converting the extracted traffic lane feature points into world coordinates, detecting a plurality of points corresponding to a traffic lane based on a previously stored traffic lane equation from the feature points which have been converted into the world coordinates, and tracking the plurality of detected points.

In an example related to the present disclosure, the controller may display the first traffic lane and the second traffic lane on the image by converting the traffic lane feature points into coordinates on an image domain, and overlapping the traffic lane feature points which have been converted into the coordinates on the image domain with the image.

In an example related to the present disclosure, the controller may convert the extracted traffic lane feature points into the world coordinates based on a previously stored homographic matrix.

In an example related to the present disclosure, the controller may detect the double lines by setting a plurality of guide lines in a horizontal direction of the image, extracting traffic lane feature points from the plurality of guide lines, and tracking the traffic lane feature points, wherein the interval between the plurality of guide lines may be gradually narrowed in a vertical direction of the image.

According to another aspect of the present invention, there is provided a traffic lane recognizing method including: receiving an image captured by a camera; detecting candidate traffic lanes from the image; detecting double lines from the detected candidate traffic lanes; selecting a first traffic lane adjacent to a vehicle from among the detected double lines, and selecting a second traffic lane adjacent to the vehicle from among the candidate traffic lanes excluding the double lines; and overlapping the first traffic lane and the second traffic lane with the image to display the same on a display unit.

In an example related to the present disclosure, in the detecting of the double lines, traffic lanes whose interval therebetween is a pre-set interval or smaller, among the detected candidate traffic lanes, may be determined as double lines.

In an example related to the present disclosure, the detecting of traffic lanes may include: extracting traffic lane feature points from the image; converting the extracted traffic lane feature points into world coordinates; and detecting the traffic lanes by tracking the traffic lane feature points which have been converted into the world coordinates.

In an example related to the present disclosure, the detecting of traffic lanes may include: extracting traffic lane feature points from the image based on pre-set guide lines; converting the extracted traffic lane feature points into world coordinates; detecting a plurality of points corresponding to a curve from the feature points which have been converted into the world coordinates based on a previously stored curve equation; and detecting the traffic lanes by tracking the plurality of detected points.

In an example related to the present disclosure, the displaying of the first traffic lane and the second traffic lane on the image may include: converting the traffic lane feature points into coordinates on an image domain; and overlapping the traffic lane feature points which have been converted into coordinates on the image domain, respectively, with the image to display the first traffic lane and the second traffic lane on the image.

In an example related to the present disclosure, the detecting of the candidate traffic lanes may include: setting a plurality of guide lines in a horizontal direction of the image; extracting traffic lane feature points from the plurality of guide lines; and detecting the candidate traffic lanes by tracking the traffic lane feature points, wherein the interval between the plurality of guide lines may be gradually narrowed in a vertical direction of the image.

### BRIEF DESCRIPTION OF DRAWINGS

FIG. 1 is a schematic block diagram showing the configuration of a traffic lane recognizing apparatus according to an embodiment of the present invention.

FIG. 2 is a flow chart illustrating a process of a traffic lane recognizing method according to an embodiment of the present invention.

FIG. 3 is a view showing an image captured by a camera according to an embodiment of the present invention.

FIG. 4 is a view showing guide lines according to an embodiment of the present invention.

FIG. 5 is a view showing feature points of traffic lanes according to an embodiment of the present invention.

FIG. 6 is a view showing feature points of traffic lanes converted into world coordinates according to an embodiment of the present invention.

FIG. 7 is a view showing a first traffic lane and a second traffic lane selected according to an embodiment of the present invention.

FIG. 8 is a view showing an image and traffic lanes displayed on a display unit according to an embodiment of the present invention.

### BEST MODE FOR CARRYING OUT THE INVENTION

The terminology used herein is for the purpose of describing particular embodiments only and is not intended to be limiting of the invention. Unless otherwise defined, all terms used herein have the same meaning as commonly understood by one of ordinary skill in the art to which this invention pertains, and should not be interpreted as having an excessively comprehensive meaning nor as having an excessively contracted meaning. If technical terms used herein is erroneous that fails to accurately express the technical idea of the present invention, it should be replaced with technical terms that allow the person in the art to properly understand. The general terms used herein should be interpreted according to the definitions in the dictionary or in the context and should not be interpreted as an excessively contracted meaning.

In the present application, it is to be understood that the terms such as “including” or “having,” etc., are intended to indicate the existence of the features, numbers, operations, actions, components, parts, or combinations thereof disclosed in the specification, and are not intended to preclude the possibility that one or more other features, numbers, operations, actions, components, parts, or combinations thereof may exist or may be added.

While terms such as “first” and “second,” etc., may be used to describe various components, such components must not be understood as being limited to the above terms. The above terms are used only to distinguish one component from another. For example, a first component may be referred to as a second component without departing from the scope of rights of the present invention, and likewise a second component may be referred to as a first component.

The exemplary embodiments of the present invention will now be described with reference to the accompanying drawings, in which like numbers refer to like elements throughout.

In describing the present invention, if a detailed explanation for a related known function or construction is considered to unnecessarily divert the gist of the present invention, such explanation has been omitted but would be understood by those skilled in the art. The accompanying drawings of the present invention aim to facilitate understanding of the present invention and should not be construed as limited to the accompanying drawings.

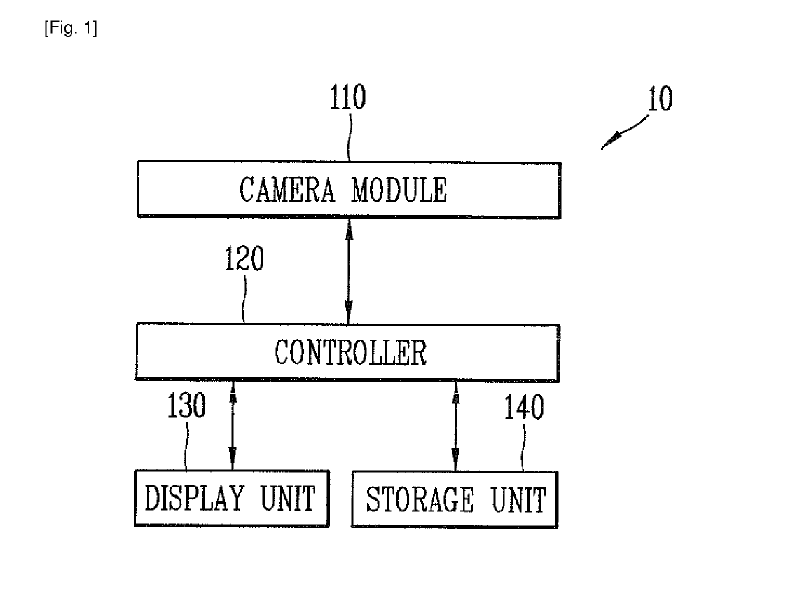

Hereinafter, the configuration of a traffic lane recognizing apparatus according to an embodiment of the present invention will be described with reference to FIG. 1. Here, the traffic lane recognizing apparatus illustrated in FIG. 1 may be configured as a stand alone device or may be applicable to various terminals such as a mobile terminal, a telematics terminal, a smart phone, a portable terminal, a personal digital assistant (PDA), a portable multimedia player (PMP), a tablet PC, a Wibro terminal, a navigation terminal, an AVN (Audio Video Navigation) terminal, and the like.

FIG. 1 is a schematic block diagram showing the configuration of a traffic lane recognizing apparatus according to an embodiment of the present invention.

As shown in FIG. 1, a traffic lane recognizing apparatus 10 according to an embodiment of the present invention includes a camera module 110, a display unit 130 displaying an image captured by the camera module 110, and a controller 120 detecting all of candidate traffic lanes from an image captured by the camera module 110, determining traffic lanes whose interval therebetween is a pre-set interval (e.g., 10 to 15 cm) or smaller, among the detected candidate traffic lanes, as double lines (e.g., a pair of white or yellow solid lines on a road, or a pair of white or yellow dotted lines on a road), selecting a first traffic lane adjacent to the vehicle from among the detected double lines, selecting a second traffic lane adjacent to the vehicle from among the candidate traffic lanes excluding the double lines, and displaying the first traffic lane and the second traffic lane as traffic lanes along which the vehicle is traveling (or moving) on. The pre-set interval may be changed according to regulations of the Road Traffic Law of each country.

The components of the traffic lane recognizing apparatus 10 illustrated in FIG. 1 are not all essential components; the traffic lane recognizing apparatus 10 may be implemented by more components or less components.

The controller 120 may set a plurality of guide lines in a horizontal direction of the image, extract traffic lane feature points (support points) on the plurality of guide lines, and track the traffic lane feature points, to detect the double lines.

The controller 120 may detect all of the traffic lanes from the image, select a first traffic lane most adjacent to the left side of the vehicle and a second traffic lane most adjacent to the right side of the vehicle based on a moving direction of the vehicle from among all of the traffic lanes, and display the first traffic lane and the second traffic lane as travel traffic lanes of the vehicle on the image.

The traffic lane recognizing apparatus 10 according to an embodiment of the present invention may include a storage unit 140 for storing a program, or the like, for detecting the image and the traffic lanes.

The camera module 110 may include at least a pair of cameras (e.g., a stereo camera, a stereoscopic camera), installed to be spaced apart horizontally on the same plane of the traffic lane recognizing apparatus 10, or a single camera. Here, the fixed horizontal interval may be set in consideration of the distance between ordinary humans two eyes. Also, the camera module 110 may be any camera modules that can capture an image.

The camera module 110 may receive a first image (e.g., a left image captured by a left camera included in the pair of cameras) and a second image (e.g., a right image captured by a right camera included in the pair of cameras) which are simultaneously captured by the pair of cameras.

The camera module 110 may be an image sensor such as a charge-coupled device (CCD), a complementary metal oxide semiconductor (CMOS), or the like.

When the traffic lane recognizing apparatus 10 is installed in a vehicle, the camera module 110 may be fixed to a certain position (e.g., a room mirror of the vehicle) of the vehicle to capture an image of a front side in the traveling direction of the vehicle. The camera module 110 may be fixedly installed at certain positions (e.g., a side mirror of the vehicle, a rear bumper of the vehicle) in order to capture images of the side and the rear side of the vehicle.

The controller 120 may extract a plurality of support points (e.g., feature points of the traffic lanes) from within any one of the first and second images received by the at least one of the pair of cameras or may extract a plurality of support points (e.g., feature points of the traffic lanes) from within an image captured by the single camera based on the pre-set guide lines. Here, a plurality of guide lines are set in a horizontal direction based on a horizontal axis with respect to the corresponding image, and as for the interval between a plurality of guide lines in a vertical axis, the interval between the guide lines at a lower portion of the image is set to be larger than the interval between the guide lines at an upper portion of the image. Namely, in order to obtain a point interval as uniform as possible in converting data of the original image (e.g., the captured image) into world coordinates, the interval between the guide lines is set to become narrow toward the upper side in the vertical direction of the image (from a lower end (lower side) to an upper end (upper side).

The controller 120 converts the plurality of extracted support points into world coordinates. Namely, the controller 120 converts the plurality of extracted support points into the world coordinates, respectively, by using a conversion matrix (including, for example, a homographic matrix, or the like), stored in the storage unit 140. Here, the plurality of support points which have been converted into the world coordinates are maintained at the same interval in the vertical direction, and accordingly, although some of the plurality of support points which have been converted in to the world coordinates have an error, the accuracy for checking such an error can be enhanced. Here, the error refers to an error with respect to an actual traffic lane.

The controller 120 detects (or checks) a plurality of points corresponding to a curve from among the points which have been converted into the world coordinates based on a traffic lane (curve/straight line) equation previously stored in the storage unit 140 with respect to the points which have been converted into the world coordinates.

In order to reduce a calibration time and noise, the controller 120 detects (recognizes) a traffic lane by tracking a plurality of points corresponding to the detected curve.

The controller 120 may also calculate the curve information that follows a virtual central point of the traffic lane based on the plurality of points corresponding to the detected curve. Here, the calculated curve information may be used to enhance traffic lane maintaining performance on the world coordinates by minimizing the influence of a calibration state of the camera. Namely, the controller 120 may calculate curve information following the central point of the traffic lane by applying any one of a least square method, a random sample consensus (RANSAC), a general hough transform method, a spline interpolation method, and the like, with respect to the plurality of points corresponding to the detected curve.

The controller 120 may overlap the calculated curve information following the central point of the traffic lane, the information such as the detected curve, or the like, with the captured image, and display the same on the display unit 130. For example, the controller 120 may convert (or map) the calculated traffic lane (straight line/curve) information following the central point of the traffic lane and the detected traffic lane information into coordinates on an image domain, respectively, overlap the respective converted coordinates with the captured image, and display the same on the display unit 130.

The controller 120 performs functions (including a traffic lane deviation warning message function, an automatic traffic lane maintaining function, and the like) in relation to maintaining a traffic lane based on the position of the traffic lane recognizing apparatus 10 (or a vehicle including the traffic lane recognizing apparatus) and the detected curve (or the traffic lane) checked through a certain GPS module (not shown).

The display unit 130 displays various contents such as various menu screen images, or the like, by using a user interface and/or a graphic user interface included in the storage unit 140 under the control of the controller 120. Here, the contents displayed on the display unit 130 includes menu screen images such as various text or image data (including various information data) and data such as an icon, a list menu, a combo box, and the like.

The display unit 130 includes a 3D display or a 2D display. Also, the display unit 130 may include at least one of a Liquid Crystal Display (LCD), a Thin Film Transistor-LCD (TFT-LCD), an Organic Light Emitting Diode (OLED) display, a flexible display, and an LED (Light Emitting Diode).

The display unit 130 displays the 3D image (or a 2D image) under the control of the controller 120.

The traffic lane recognizing apparatus 10 may include two or more display units 130 according to its particular desired embodiment. For example, a plurality of display units may be separately or integrally disposed on a single face (the same surface) of the traffic lane recognizing apparatus 10, or may be disposed on mutually different faces of the traffic lane recognizing apparatus 10.

Meanwhile, when the display unit 130 and a sensor sensing a touch operation (referred to as a ‘touch sensor’, hereinafter) are overlaid in a layered manner (referred to as a ‘touch screen’, hereinafter), the display unit 130 may function as both an input device and an output device. The touch sensor may have the form of, for example, a touch film, a touch sheet, a touch pad, a touch panel, and the like.

The touch sensor may be configured to convert the pressure applied to a particular portion of the display unit 130 or a change in capacitance generated at a particular portion of the display unit 130 into an electrical input signal. Also, the touch sensor may be configured to detect a touch input pressure as well as a touch input position and a touch input area. When there is a touch input with respect to the touch sensor, the corresponding signal(s) are sent to a touch controller (not shown). The touch controller processes the signal(s) and transmits corresponding data to the controller 120. Accordingly, the controller 120 can recognize a touched region of the display unit 151.

The display unit 130 may include a proximity sensor. The proximity sensor may be disposed in an internal region of the traffic lane recognizing apparatus 10 covered by the touch screen or in the vicinity of the touch screen.

The proximity sensor may be disposed within the mobile terminal covered by the touch screen or near the touch screen. The proximity sensor refers to a sensor for detecting the presence or absence of an object that accesses a certain detect surface or an object that exists nearby by using the force of electromagnetism or infrared rays without a mechanical contact. Thus, the proximity sensor has a longer life span compared with a contact type sensor, and it can be utilized for various purposes. Examples of the proximity sensor may include a transmission type photoelectric sensor, a direct reflection type photoelectric sensor, a minor-reflection type photo-electric sensor, an RF oscillation type proximity sensor, a capacitance type proximity sensor, a magnetic proximity sensor, an infrared proximity sensor, and the like. When the touch screen is an electrostatic type touch screen, an approach of the pointer is detected based on a change in an electric field according to the approach of the pointer. In this case, the touch screen (touch sensor) may be classified as a proximity sensor.

Recognition of a pointer positioned to be close to the touch screen without being contacted may be called a ‘proximity touch’, while recognition of actual contacting of the pointer on the touch screen may be called a ‘contact touch’. In this case, when the pointer is in the state of the proximity touch, it means that the pointer is positioned to correspond vertically to the touch screen.

The proximity sensor detects a proximity touch and a proximity touch pattern (e.g., a proximity touch distance, a proximity touch speed, a proximity touch time, a proximity touch position, a proximity touch movement state, or the like), and information corresponding to the detected proximity touch operation and the proximity touch pattern can be outputted to the touch screen.

When the display unit 130 is used as an input device, it may receive a user's button manipulation or receive a command or a control signal generated according to a manipulation such as touching/scrolling a displayed screen image.

The storage unit 140 may further store various menu screen images, a user interface (UIs), and/or a graphic user interface (GUI).

The storage unit 140 may further store mathematical equations such as a conversion matrix (e.g., homographic matrix, and the like), a curve equation, the least square method, and the like.

The storage unit 140 may further store data, programs, and the like, required for operating the traffic lane recognizing apparatus 10.

The storage unit 140 may include at least one type of storage mediums including a flash memory type, a hard disk type, a multimedia card micro type, a card-type memory (e.g., SD or DX memory, etc), a Read-Only Memory (ROM), an Electrically Erasable Programmable Read-Only Memory (EEPROM), a Programmable Read-Only memory (PROM), a Random Access Memory (RAM), a Static Random Access Memory (SRAM), a magnetic memory, a magnetic disk, and an optical disk.

The traffic lane recognizing apparatus 10 may further include a communication unit (not shown) performing a communication function with a certain terminal or a server under the control of the controller 120. Here, the communication unit may include a wired/wireless communication module. Here, a wireless Internet technique may include a wireless local area network (WLAN), Wi-Fi, wireless broadband (WiBro), world interoperability for microwave access (WiMAX), high speed downlink packet access (HSDPA), IEEE802.16, long-term evolution (LTE), a wireless mobile broadband service (WMBS), and the like, and a short-range communication technology include Bluetooth™, Radio Frequency IDentification (RFID), Infrared Data Association (IrDA), Ultra-WideB and (UWB), ZigBee™, and the like. Also, the wired communication technique may include USB (Universal Serial Bus) communication, and the like.

The communication unit may include CAN communication, vehicle Ethernet, flexray, LIN (Local Interconnect Network), and the like, for communication with a certain vehicle in which the traffic lane recognizing apparatus 10 is provided.

The communication unit may transmit curve information, or the like, that follows a central point of a traffic lane calculated based on a plurality of support points extracted from a certain image under the control of the controller 120, points obtained by converting the plurality of support points into world coordinates, a plurality of points corresponding to a curve among points which have been converted into the world coordinates, and a plurality of curves corresponding to the curve, to the certain terminal or server.

The communication unit may receive a first image and a second image, which were simultaneously captured by a pair of stereo cameras, transmitted from the certain terminal or server.

The traffic lane recognizing apparatus 10 may further include an input unit (not shown) including one or more microphones (not shown) for receiving an audio signal.

The microphone receives an external audio signal (including a user s voice (voice signal or voice information)) in a phone call mode, a recording mode, a voice recognition mode, and the like, and processes the audio signal into electrical voice data. The processed voice data processed by the microphone may be output through a voice output unit (not shown) or converted into a format that is transmittable and output to an external terminal through the communication unit. The microphone may implement various types of noise canceling algorithms to cancel noise generated in a procedure of receiving the external audio signal.

The input unit receives a signal according to a user's button manipulation or receives a command or a control signal generated according to a manipulation such as touching/scrolling a displayed screen image.

The input unit receives a signal corresponding to information input by the user, and as the input unit, various devices such as a keyboard, a keypad, a dome switch, a touch pad (pressure/capacitance), a touch screen, a jog shuttle, a jog wheel, a jog switch, a mouse, a stylus, pen, a touch pen, a laser pointer, and the like, may be used. Here, the input unit receives signals corresponding to inputs by various devices.

The traffic lane recognizing apparatus 10 may further include a voice output unit (not shown) outputting voice information included in the signal processed by the controller 120. Here, the voice output unit may be a speaker.

In the traffic lane recognizing apparatus and method according to an embodiment of the present invention, support points (feature points) as a candidate group of a traffic lane are extracted from an image and converted into world coordinates, and a traffic lane is recognized on the converted world coordinates. Thus, a possibility of an accumulated error can be reduced compared with the method of directly recognizing a traffic lane from an image in an error transition of calibration between camera information and the world coordinates.

In the traffic lane recognizing apparatus and method according to an embodiment of the present invention, information regarding a traffic lane recognized from the world coordinates is displayed, based on which a warning message is generated and output, thereby enhancing accuracy/sensitivity and user convenience.

In the traffic lane recognizing apparatus and method according to an embodiment of the present invention, double lines (e.g., a pair of white or yellow solid lines on a road, or a pair of white or yellow dotted lines on a road) are detected from candidate traffic lanes within an image, and a traffic lane adjacent to a vehicle is detected from among the double lines, whereby a traffic lane recognition error caused as the double lines are bifurcated at a junction of roads can be prevented.

In the traffic lane recognizing apparatus and method according to an embodiment of the present invention, double lines are detected from candidate traffic lanes within an image, and a traffic lane adjacent to a vehicle is detected from the double lines, thereby accurately generate a traffic lane deviation alarm. For example, when an outer traffic lane among the double lines is detected as a traffic lane along which the vehicle is traveling (or moving) on, if the vehicle runs on an inner traffic lane (e.g., a traffic lane adjacent to the vehicle among the double lines 301) among the double lines, a traffic lane deviation alarm is not generated. However, in the traffic lane recognizing apparatus and method according to an embodiment of the present invention, double lines are detected from candidate traffic lanes within an image, and a traffic lane adjacent to the vehicle is detected from among the double lines, thereby accurately generating a traffic lane deviation alarm.

A traffic lane recognizing method according to an embodiment of the present invention will be described in detail with reference to FIGS. 1 through 8.

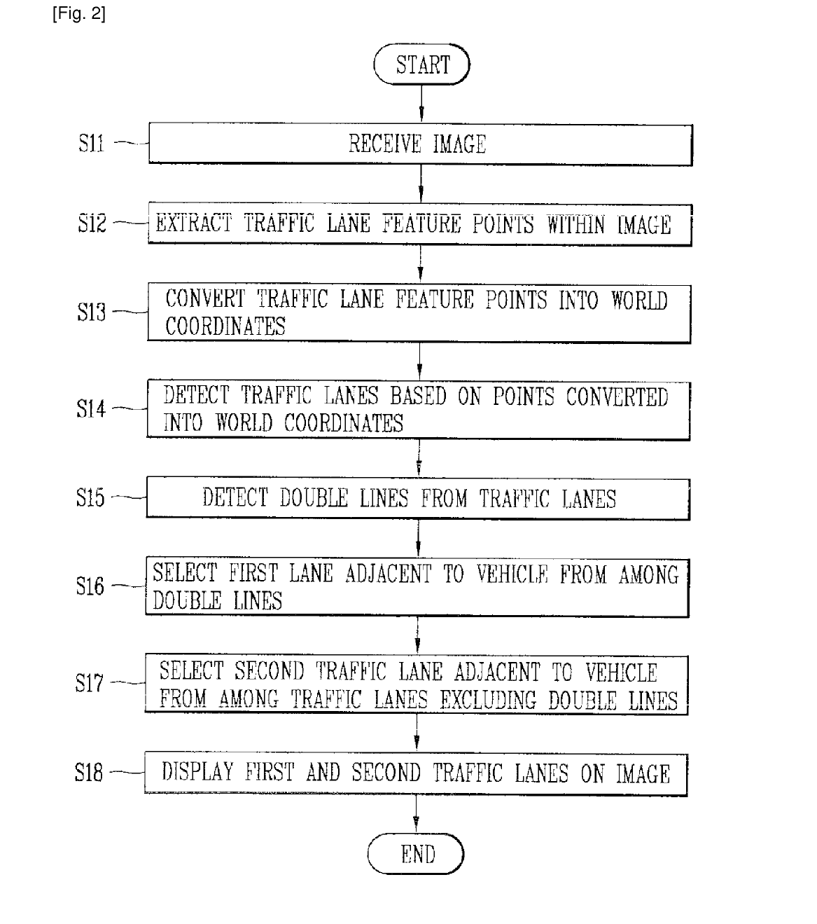

FIG. 2 is a flow chart illustrating a process of a traffic lane recognizing method according to an embodiment of the present invention.

First, the camera module 110 receives a first image and a second image captured by at least a pair of cameras (e.g., a stereo camera or a stereoscopic camera) installed separately by a horizontal interval on the same central axis of the same surface of the traffic lane recognizing apparatus 10, or receives an image captured by a single camera. Here, the first image may be a left image captured by a left camera included in the pair of cameras and the second image may be a right image captured by a right camera included in the pair of cameras. Also, the camera module 110 may receive any one of the first image and the second image captured by the pair of cameras.

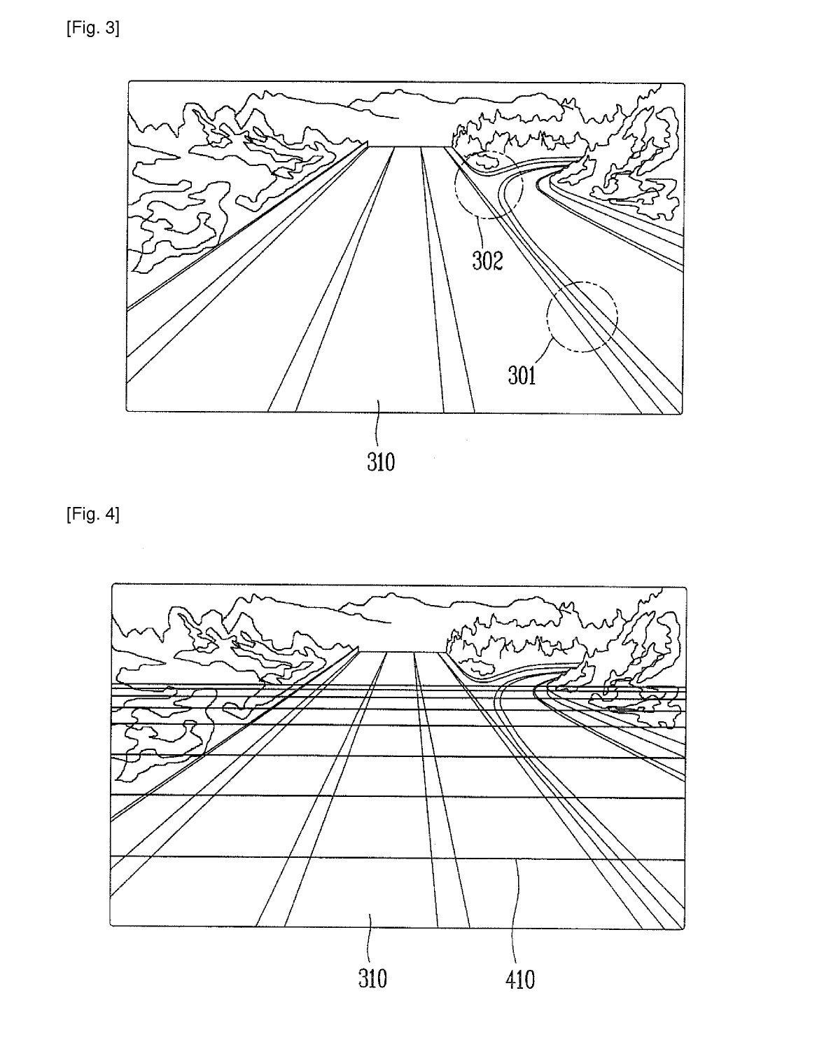

FIG. 3 is a view showing an image captured by a camera according to an embodiment of the present invention.

As shown in FIG. 3, the camera module 110 receives an image 310 captured by a single camera (S11). For example, the camera module 110 may receive the image 310 including traffic lanes corresponding to a first lane, a second lane, a third lane, and the like, and double lines 301 of white or yellow sold lines (or double lines of white or yellow solid lines and dotted lines). Here, if an outer traffic lane among the double lines 301 (e.g., a traffic lane farther from a vehicle, among the double lines 301) is detected as a traffic lane along which the vehicle is traveling (or moving) on, since the double lines 301 are bifurcated at a joint 302, a traffic lane recognition (detection) error occurs. Also, when the outer traffic lane among the double lines 301 is detected as a traffic lane along which the vehicle is traveling (or moving) on, if the vehicle is running on the inner traffic lane among the double lines 301 (e.g., the traffic lane adjacent to the vehicle, among the double lines 301), a traffic lane deviation alarm is not generated.

The controller 120 receives the image 310 through the camera module 110, and extracts a plurality of support points (e.g., feature points of a traffic lane) from the captured image 310 based on pre-set guide lines for extracting support points from the image 310 (S12). Here, as for the guide lines, as shown in FIG. 4, when a lower portion of the image 310 is converted into world coordinates, it represents a closer region, and when middle and upper portions of the image 310 are converted into world coordinates, they represent a distant region. Thus, in order to obtain point intervals as uniform as possible when data of the image 310 is converted into the world coordinates, the lower portion of the image 310 is set to have a wider interval between lines and the interval between lines of the guide lines 410 is gradually narrowed toward the upper portion of the image 310. Here, a change width of the interval between lines of the guide lines 410 may be variably set according to a design of a designer and may be set to maintain the equal interval between lines when the data of the image 310 is converted into world coordinates. The guide line refers to a virtual line used to obtain a point interval as uniform as possible when the support points (feature points) are converted into the world coordinates, rather than being actually displayed on the image.

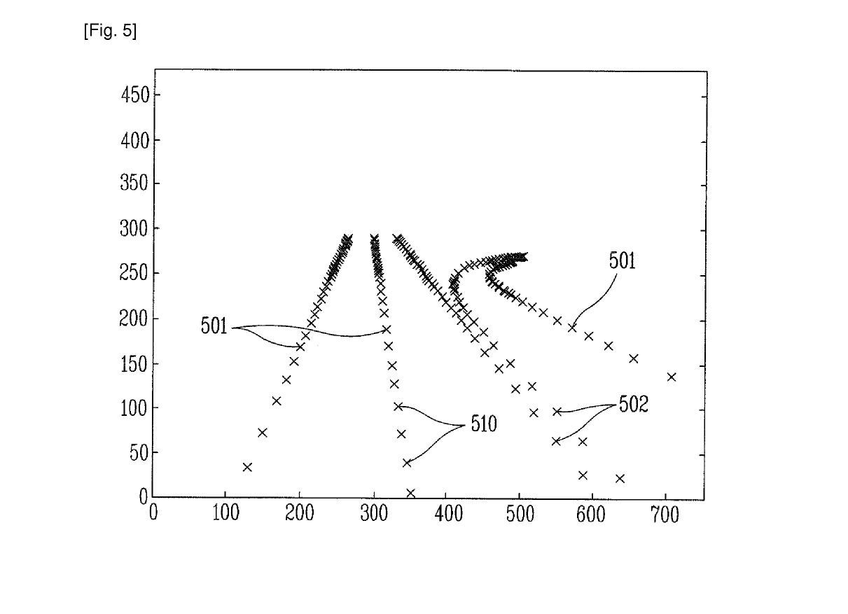

As shown in FIG. 5, the controller 120 extracts a plurality of support points (traffic lane feature points) from the image 310 based on the pre-set guide lines, and displays the plurality of extracted support points 510 on an image domain of the display unit 130. Namely, the controller 120 displays the support points corresponding to the traffic lanes 501 and the support points corresponding to the double lines 502 on the image domain. Here, the interval between the plurality of support points in a vertical direction based on the horizontal axis (x axis) is gradually narrowed from a lower side to an upper side of the display unit 130 in the vertical direction.

The controller 120 converts the plurality of extracted support points into world coordinates (S13). Namely, the controller 120 may convert the plurality of extracted support points into world coordinates by using a conversion matrix (e.g., a homographic matrix), or the like) previously stored in the storage unit 140.

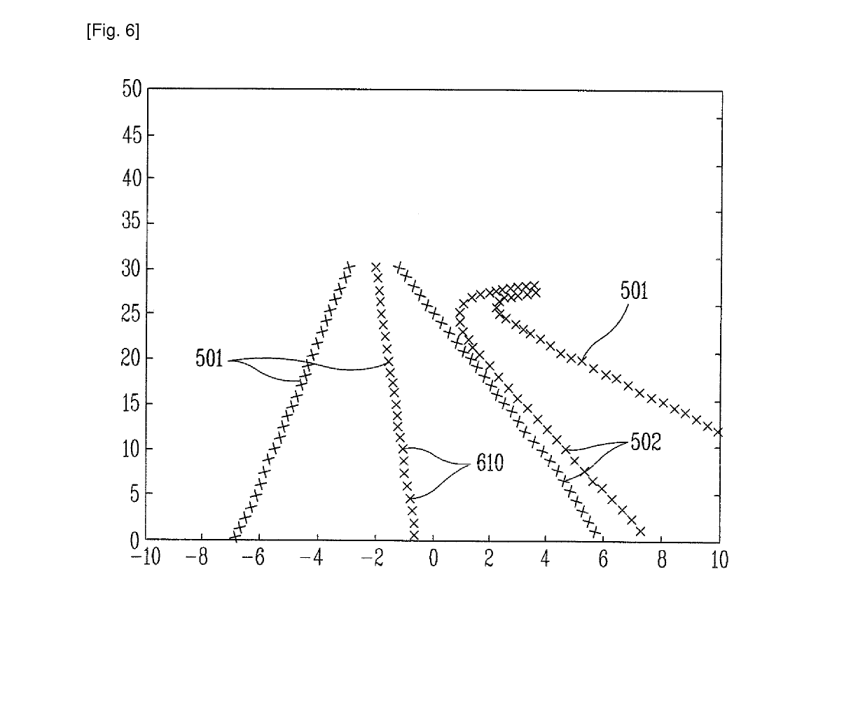

For example, as shown in FIG. 6, the controller 120 converts the plurality of extracted support points into world coordinates based on the homographic matrix previously stored in the storage unit 140, and displays a plurality of support points 610 which have been converted into the world coordinates on the display unit 130. Here, based on the horizontal axis, the interval between the plurality of support points which have been converted into the world coordinates in the vertical direction is maintained to be equal.

The controller 120 may detect (or check) a plurality of points corresponding to a curve among the plurality of points which have been converted into the world coordinates based on the plurality of support points which have been converted into the world coordinates and a curve equation previously stored in the storage unit 140. Namely, the controller 120 may substitute the plurality of support points which have been converted into the world coordinates to the curve equation previously stored in the storage unit 140 and determine (or check) whether the plurality of support points which have been converted into the world coordinates make a curve based on the substitution results. Here, the curve equation may be a quadratic equation or higher.

The controller 120 substitutes the plurality of support points which have been converted into the world coordinates to a quadratic curve equation (e.g., y=ax²+bx+c, wherein a is a curvature, b is a tilt (or heading), and c is an offset) previously stored in the storage unit 140. When a=0, the controller 120 recognizes the plurality of support points as a straight line, and when a 0, the controller 120 recognizes the plurality of support points as a curve.

The controller 120 substitutes the plurality of support points which have been converted into the world coordinates to a cubic curve equation (e.g., y=ax³+bx²+cx+d, wherein a is a curve derivative, b is a curvature, c is a heading, and d is an offset) previously stored in the storage unit 140, to check whether the plurality of support points form a curve. Here, in the cubic curve equation, when a is 0, b is a curvature of a traffic lane, c is a heading of the vehicle, and d is an offset, and when both a and b are 0, indicating detection of a straight line, c is a heading of a vehicle and d is an offset.

The controller 120 may detect traffic lanes by tracking the plurality of support points which have been converted into the world coordinates or detect traffic lanes by tracking a plurality of points corresponding to the detected curve (S14).

The controller 120 may calculate curve information that follows a central point of a traffic lane with respect to the plurality of points corresponding to the detected curve. Here, the calculated curve information may be used to enhance a traffic lane maintaining performance on the world coordinates by minimizing the influence of a calibration state of the camera. For example, the controller 120 may calculate curve information that follows a central point of a traffic lane by using any one of the least square method, the random sample consensus (RANSAC), the general hough transform method, the spline interpolation method, and the like, with respect to the plurality of points corresponding to the detected curve, and display the calculated curve information on the display unit 130.

The controller 150 detects double lines from among the detected traffic lanes (S15).

For example, the controller 120 determines traffic lanes whose interval therebetween is a pre-set interval (e.g., 10 to 15 cm) or smaller, among the detected traffic lanes, as double lines (e.g., a pair of white or yellow solid lines on a road, or a pair of white or yellow dotted lines on a road). For example, the controller 120 calculates a distance value based on pixels positioned between traffic lanes (i.e., pixels corresponding to a straight line connecting the traffic lanes). Here, each pixel may have the same distance value or different distance value. Namely, when it is assumed that 30 pixels are positioned between two traffic lanes and a distance value previously set for each pixel is 1 cm, a distance value between two traffic lanes is 30 cm (1 cm*30=30 cm).

The controller 120 selects a first traffic lane most adjacent to the vehicle from among the detected double lines (S16) and selects a second traffic lane most adjacent to the vehicle from among the traffic lanes (candidate traffic lanes) excluding the double lines (S17). Namely, the controller 120 automatically determines the traffic lane along which the vehicle is traveling (or moving) on among the traffic lanes including the detected double lines.

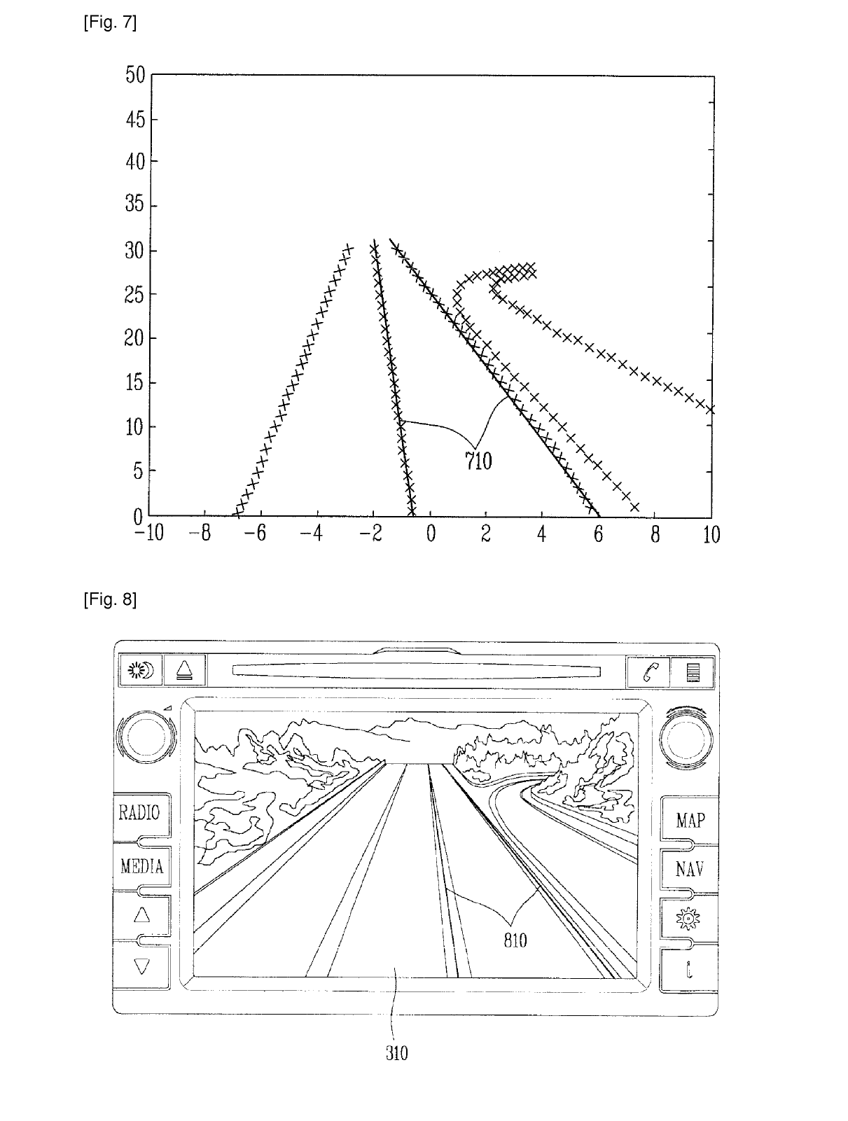

FIG. 7 is a view showing a first traffic lane and a second traffic lane 710 selected according to an embodiment of the present invention.

As shown in FIG. 7, the controller 120 selects the first traffic lane 710 most adjacent to the vehicle among the detected double lines, and selects the second traffic lane 710 most adjacent to the vehicle among the traffic lanes (candidate traffic lanes) excluding the double lines.

The controller 120 displays the first traffic lane and the second traffic lane on the image by overlapping the first traffic lane and the second traffic lane on the image (S18). For example, the controller 120 converts (or maps) the detected first traffic lane and the second traffic lane 710 into coordinates on the image domain, and overlaps the respective converted coordinates on the image 310.

FIG. 8 is a view showing an image and traffic lanes displayed on a display unit according to an embodiment of the present invention.

As shown in FIG. 8, the controller 120 detects the double lines and selects (detects) a traffic lane 810 adjacent to the vehicle from among the double lines, thereby preventing a traffic lane (detection) recognition error phenomenon that occurs due to a marking (e.g., an arrow indicating a direction, the name of a place, distance information, and the like) on a road, and thus, accurately detecting a traffic lane along which the vehicle is traveling (or moving) on. Namely, the controller 120 selects the first traffic lane 810 most adjacent to the vehicle from among the detected double lines, selects the second traffic lane 810 most adjacent to the vehicle from among the traffic lanes (candidate traffic lanes) excluding the double lines, and displays the selected first and second traffic lanes 810 on the image.

Meanwhile, the controller 120 performs a function related to maintaining the traffic lane (including a traffic lane deviation alarm message function, an automatic traffic lane maintaining function, and the like) based on the position of the traffic lane recognizing apparatus 10 (or the vehicle including the traffic lane recognizing apparatus 10) checked through a certain GPS module (not shown) and the checked curve (or traffic lane).

As described above, in the traffic lane recognizing apparatus and method according to an embodiment of the present invention, double lines (e.g., a pair of white or yellow solid lines on a road, or a pair of white or yellow dotted lines on a road) are detected from candidate traffic lanes within an image, and a traffic lane adjacent to a vehicle is detected from among the double lines, whereby a traffic lane recognition error caused as the double lines are bifurcated at a junction of roads can be prevented.

In the traffic lane recognizing apparatus and method according to an embodiment of the present invention, double lines are detected from candidate traffic lanes within an image, and a traffic lane adjacent to a vehicle is detected from the double lines, thereby accurately generate a traffic lane deviation alarm. For example, when an outer traffic lane among the double lines is detected as a traffic lane along which the vehicle is traveling (or moving) on, if the vehicle runs on an inner traffic lane (e.g., a traffic lane adjacent to the vehicle among the double lines 301) among the double lines, a traffic lane deviation alarm is not generated. However, in the traffic lane recognizing apparatus and method according to an embodiment of the present invention, double lines are detected from candidate traffic lanes within an image, and a traffic lane adjacent to the vehicle is detected from among the double lines, thereby accurately generating a traffic lane deviation alarm.

In the traffic lane recognizing apparatus and method according to an embodiment of the present invention, double lines (e.g., a pair of white or yellow solid lines on a road, or a pair of white or yellow dotted lines on a road) are detected from candidate traffic lanes within an image, and a traffic lane adjacent to a vehicle is detected from among the double lines, thereby preventing a traffic lane (detection) recognition error phenomenon that occurs due to a marking (e.g., an arrow indicating a direction, the name of a place, distance information, and the like) on a road, and thus, accurately detecting a traffic lane along which the vehicle is traveling (or moving) on.

1. A traffic lane recognizing apparatus comprising:
a camera module;
a display unit configured to display an image captured by the camera module; and
a controller configured to detect candidate traffic lanes from an image captured by the camera module, detect double lines from the detected candidate traffic lanes, select a first traffic lane adjacent to a vehicle from among the detected double lines, select a second traffic lane adjacent to the vehicle from among the candidate traffic lanes, exclude the double lines, and display the first traffic lane and the second traffic lane on the image,
wherein the controller determines traffic lanes whose interval therebetween is a pre-set interval or smaller, among the detected candidate traffic lanes, as the double lines, and an interval of the double lines is smaller than an interval of the first and second traffic lanes.

2. (canceled)

3. The traffic lane recognizing apparatus of claim 1, wherein the double lines are double lines of solid lines, double lines of dotted lines, or double lines of a solid line and a dotted line.

4. The traffic lane recognizing apparatus of claim 1, wherein the controller detects the traffic lanes by extracting traffic lane feature points from the image, converting the extracted traffic lane feature points into world coordinates, and tracking the traffic lane feature points which have been converted into the world coordinates.

5. The traffic lane recognizing apparatus of claim 1, wherein the controller detects the traffic lanes by extracting traffic lane feature points from the image based on pre-set guide lines, converting the extracted traffic lane feature points into world coordinates, detecting a plurality of points corresponding to a traffic lane based on a previously stored traffic lane equation from the feature points which have been converted into the world coordinates, and tracking the plurality of detected points.

6. The traffic lane recognizing apparatus of claim 5, wherein the controller displays the first and second traffic lanes on the image by converting the traffic lane feature points into coordinates on an image domain, and overlapping the traffic lane feature points which have been converted into the coordinates on the image domain with the image.

7. The traffic lane recognizing apparatus of claim 5, wherein the controller converts the extracted traffic lane feature points into the world coordinates based on a previously stored homographic matrix.

8. The traffic lane recognizing apparatus of claim 1, wherein the controller detects the double lines by setting a plurality of guide lines in a horizontal direction of the image, extracting traffic lane feature points from the plurality of guide lines, and tracking the traffic lane feature points.

9. The traffic lane recognizing apparatus of claim 1, wherein the interval between the plurality of guide lines is gradually narrowed in a vertical direction of the image.

10. A traffic lane recognizing method comprising:
receiving an image captured by a camera;
detecting candidate traffic lanes from the image;
detecting double lines from the detected candidate traffic lanes;
selecting a first traffic lane adjacent to a vehicle from among the detected double lines, and selecting a second traffic lane adjacent to the vehicle from among the candidate traffic lanes excluding the double lines; and
overlapping the first and second traffic lanes with the image to display the same on a display unit,.
wherein traffic lanes whose interval therebetween is a pre-set interval or smaller, among the detected candidate traffic lanes, are determined as the double lines, and an interval of the double lines is smaller than an interval of the first and second traffic lanes.

11. (canceled)

12. The method of claim 10, wherein the double lines are double lines of solid lines, double lines of dotted lines, or double lines of a solid line and a dotted line.

13. The method of claim 10, wherein the detecting of traffic lanes comprises:
extracting traffic lane feature points from the image;
converting the extracted traffic lane feature points into world coordinates; and
detecting the traffic lanes by tracking the traffic lane feature points which have been converted into the world coordinates.

14. The method of claim 10, wherein the detecting of traffic lanes comprises:
extracting traffic lane feature points from the image based on pre-set guide lines;
converting the extracted traffic lane feature points into world coordinates;
detecting a plurality of points corresponding to a curve from the feature points which have been converted into the world coordinates based on a previously stored curve equation; and
detecting the traffic lanes by tracking the plurality of detected points.

15. The method of claim 14, wherein the displaying of the first and second traffic lanes on the image comprises:
converting the traffic lane feature points into coordinates on an image domain; and
overlapping the traffic lane feature points which have been converted into coordinates on the image domain, respectively, with the image to display the first and second traffic lanes on the image.

16. The method of claim 14, wherein the extracted traffic lane feature points are converted into the world coordinates based on a previously stored homographic matrix.

17. The method of claim 10, wherein the detecting of the candidate traffic lanes comprises:
setting a plurality of guide lines in a horizontal direction of the image;
extracting traffic lane feature points from the plurality of guide lines; and
detecting the candidate traffic lanes by tracking the traffic lane feature points.

18. The method of claim 17, wherein the interval between the plurality of guide lines is gradually narrowed in a vertical direction of the image.
